(19) United States
(12) Patent Application Publication
(10) Pub. No.: US 2014/0193795 A1
(43) Pub. Date: Jul. 10, 2014

(54) DYNAMIC GENERATION OF ELECTRONIC EDUCATIONAL COURSES

(71) Applicant: You Can Learn, Inc., Land O'Lakes, FL (US)

(72) Inventors: Joseph F. Tavolacci, Land O' Lakes, FL (US); Mark R. Turner, Tampa, FL (US); Nael Al Qattan, Safat (KW)

(73) Assignee: You Can Learn, Inc., Land O'Lakes, FL (US)

(21) Appl. No.: 13/956,454

(22) Filed: Aug. 1, 2013

Related U.S. Application Data
(60) Provisional application No. 61/678,146, filed on Aug. 1, 2012.

(51) Int. Cl. G09B 7/00

(52) U.S. Cl. CPC G09B 7/00
USPC 434/362

(57) ABSTRACT

A method of dynamically generating electronically presented educational courses. The automated method evaluates a user's skill levels and desires and dynamically constructs a lesson plan specifically tailored to the user's desires and understanding of the subject material. Also included are a software application utilizing the method and a mobile device having a software application utilizing the method.

### CROSS-REFERENCE TO RELATED APPLICATION

This application claims priority benefit of U.S. Provisional Patent Application No. 61/678,146 entitled “DYNAMIC GENERATION OF ELECTRONIC EDUCATIONAL COURSES,” filed on Aug. 1, 2012, by Joseph F. Tavolacci, the entire disclosure of which is incorporated herein by reference.

### FIELD OF INVENTION

This invention relates to educational software; more specifically, to the dynamic generation of electronic educational courses.

### BACKGROUND OF THE INVENTION

The educational and workplace landscapes are changing before us, creating an increased demand for flexibility, continued independent education, and cooperation instead of simple accumulation of skills and knowledge. Rifkin suggests that the era where an employee's worth is determined by the market value is coming to an end. Rifkin, J., The end of work: The decline of the global labor force and the dawn of the post market era. New York: G. P. Putnam's Sons 1995. Creativity is beginning to replace knowledge depth in determining an employee's value, while the ability to work in a collaborative team environment is a rising prerequisite for many employment opportunities. This produces a need to develop instructional practices to support a self-directed, lifelong learner.

These changes create challenges that make it necessary to adapt presentations of educational material to the learning styles of different students. This demands the right amount of information be presented with the proper knowledge depth based on the current level of the student to create an engaging and efficient instructional environment.

The goal of education is viewed as the transmission of knowledge by the teacher to the students. This is called convergent teaching, which creates a highly structured environment that is teacher-centric. It is often viewed as the direct opposition of divergent teaching, which fosters the goal of autonomous learning and self-expression. This is student-centric learning, which is flexible and often uses self-evaluation tools in conjunction with teacher evaluation.

Some educators have begun to acknowledge the importance of adapting teaching strategies to individual student learning styles, but minimal efforts have been made to make this approach universal, or merge it with technology. Thus, a divergent teaching approach utilizing current technology that is customized to individual needs is desirable.

### SUMMARY OF THE INVENTION

The methods and systems of the present invention are built around an innovative approach to the educational process. Instead of using a one-size-fits-all presentation methodology as in prior art, the methods and systems of the present invention present information in a dynamic and user-friendly format that caters to a user's individual learning style and needs.

The methods and systems of the present invention allow for continuous, automated assurance that each student has achieved the appropriate level of prerequisite knowledge that is required to advance in lessons. This is achieved with a pre-lesson assessment before new material is taught, intra-lesson assessment during each lesson, a brief post-lesson assessment, and other continuous assessment tools throughout the course. To balance teaching, users who have achieved a certain level of knowledge are presented a cursory, brief version of a given lesson, while a user who has little to no prerequisite knowledge is given a detailed presentation, and is routed back to lessons containing the foundational information when needed.

Because of the dynamic nature in which the application is presented, and the evaluation of the user's current level of expertise, the user can repeat the educational courses (and the automated method) many times—each time expanding their knowledge on the sub-subjects needed most.

The present invention also includes a similar post presentation evaluation method. In this method, each time the user is evaluated, the questioning order and content will be unique, thus providing the user with a reliable assessment of the knowledge gained.

The present invention may be in the form of a mobile application which can be hosted on devices such as tablets or mobile phones and may include a wide variety of subject matter ranging from history to entertainment to personal growth.

### BRIEF DESCRIPTION OF THE DRAWINGS

For a fuller understanding of the invention, reference should be made to the following detailed description, taken in connection with the accompanying drawings, in which:

FIG. 1 is a diagram of an exemplary controlled feedback loop.

FIG. 2 is a diagram of a method and system of dynamically generating electronic educational courses according to an embodiment of the present invention.

FIG. 3A is a flowchart of a high-level overview of a method and system of dynamically generating electronic educational courses according to an embodiment of the present invention.

FIG. 3B is a flowchart of a detailed overview of a method and system of dynamically generating electronic educational courses according to an embodiment of the present invention.

FIG. 4 is a flowchart illustrating level selection portion of a method and system of dynamically generating electronic educational courses according to an embodiment of the present invention.

FIG. 5 is a flowchart illustrating presentation level selection portion of a method and system of dynamically generating electronic educational courses according to an embodiment of the present invention.

FIG. 6 is a block diagram providing an illustration of an exemplary mobile device on which the electronic education courses may be presented in accordance with an embodiment of the present invention

FIG. 7 is a flowchart illustrating an exemplary menu and resulting functions of the menu options according to an embodiment of the present invention.

### DETAILED DESCRIPTION OF THE PREFERRED EMBODIMENTS

In the following detailed description of the embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

An embodiment of the present invention includes a method of dynamically generating electronically presented educational courses based on a user's demonstrated knowledge and progress. The automated method evaluates a user's skill levels and requirements and dynamically constructs a lesson plan specifically tailored to the user's requirements and understanding of the subject material.

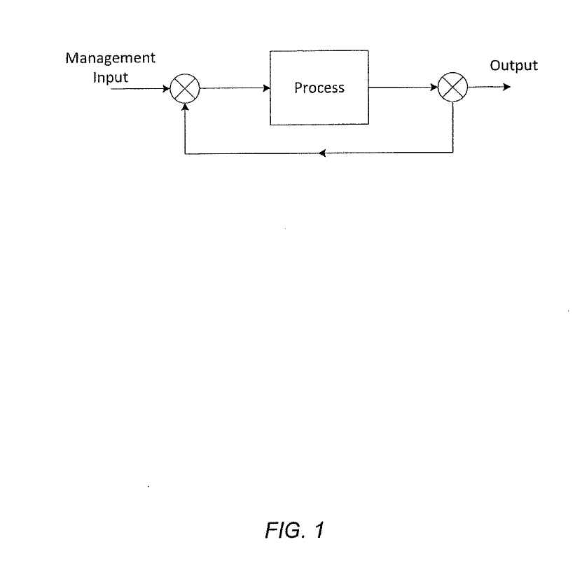

FIG. 1 is a diagram of a controlled feedback loop which helps illustrate the mechanics of embodiments of the present invention. In the figure, Management Input represents the course material and the process is how the student absorbs the information in the course. The monitor represents the assessment method that determines student understanding. The monitor then uses the assessment to control the amount of information delivered to the student until the final goal of mastery (output) is achieved.

The subject presentations of the courses are dynamically constructed based on the user's requests and knowledge base by employing embodiments of the method, which utilizes a pre-utilization user evaluation survey and an associated key evaluation data string. The method also includes a novel weighting system which provides for the ability to use not only multiple choice questions, but also true/false and column A—Column B match questions. The mobile application also contains a customized menu, a complete manual, and a host of supporting tools that enable the user to use the application not only as a course presentation tool, but also as a quick reference guide and subject refresher. The presentation can be viewed multiple times, each time at the same or different depth level of information, allowing the viewer to gain a deeper understanding of each lesson's objective.

The present invention also includes a similar post-level presentation evaluation method, which uses a post-level presentation question set. In this method, each time the user is evaluated, the questioning order and content will be unique thus providing the user with a reliable assessment of the knowledge gained.

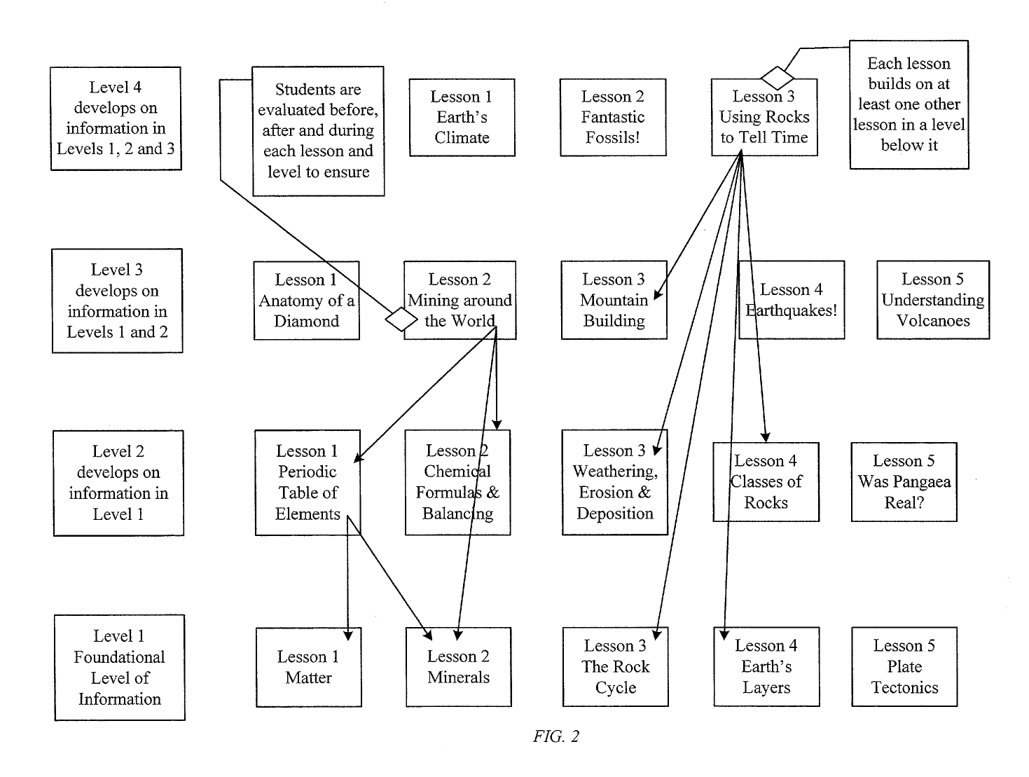

A diagram of an embodiment is shown in FIG. 2. The invention takes a networked approach to learning by beginning with a foundational level of information and expanding it into a more progressive and rigorous body of knowledge. Users cover material based on their mastery of previous concepts through a continuous assessment of learning objectives. Course content is adjusted accordingly, providing the student with the necessary instruction in needed areas. FIG. 2 shows the relationships of the individual subparts (levels, lessons, and learning objectives) of the software application. The rows represent the levels, the blocks represent the lesson, and the contents of the blocks represent the learning objectives. Each level of learning adds to, utilizes, and reinforces the knowledge gained from the lower levels building a solid foundation/mastery of the overall subject.

The methods and resulting software applications facilitate and promote the learning process by design and content by:
providing a body of knowledge through a series of lessons that are based on content standards and/or identified learning objectives;
presenting the core body of knowledge in levels of increasingly higher levels of knowledge and thought which build on the levels preceding it. The more the student has learned, the more detailed the presented information becomes;
establishing a baseline for learning by pre-assessing each individual user to determine the level of background knowledge and understanding of the material to be presented;
adjusting the level of content delivery as the course progresses by means of adaptive assessment. Students are assessed not only at the beginning and end of a course; they are evaluated as they cover content throughout each lesson. Students are presented with brief, standard, and detailed versions of information based on continuous assessment;
increasing student retention through reiterative presentations of course material. If a student does not demonstrate mastery of a specific learning objective then an expanded presentation of the information is given providing additional opportunities for the student to grasp the missed skill in a new and dynamic way;
creating student engagement through dynamic course content such as video, audio, interactive images, animations, digital flashcards, 3D models, interactive puzzles, etc. Each student has a preferred learning style; therefore, various modalities are employed to meet the needs of visual, auditory, linguistic, kinesthetic, and logical learners.

Elements of embodiment of the present invention include:
Lesson Learning Objectives—For each lesson, specific goals for student learning are established. Lesson objectives state what concepts should be mastered by the end of each lesson. A master listing of all course objectives is also included in the application.
Presentation Material—The actual course content arranged by level/lesson/learning objective with each structured as a standalone module (each to be displayed on a scrollable page). The typical application contains from 3 to 5 levels of content and each level contains from 5 to 12 lessons.
There are typically a minimum of three versions of the information presented in each application level/lesson/learning objective
   LV01-LE01-LOBJ01—Brief (Level 1-Lesson 1-Learning Objective 1-Brief)
   LV01-LE01-LOBJ01-Standard (Level 1-Lesson 1-Learning Objective 1-Standard)
   LV01-LE01-LOBJ01-Detailed (Level 1-Lesson 1-Learning Objective 1-Detailed)
Presentation Levels:
   Brief presentation—General overview of information is given including only key facts.
   Standard presentation—An expanded version of the brief presentation including some additional top-level details is presented.
   Detailed presentation—An extensive and very detailed presentation of the lesson's learning objective is presented.
Question Sets—the applications use carefully crafted question sets that go beyond factual knowledge to ensure students are meeting prescribed learning objectives. By utilizing levels of questions based on Bloom's Taxonomy, students are guided to operate at higher levels of thinking. The questions in the applications are used to teach the students not just to test them.
   Students are asked questions in the courses at the following levels:
      Knowledge—Lowest level of questions. Requires recall of information.
      Comprehension—Require students to combine data together.
      Application—Students take information they know and determine a correct response.
      Analysis—Students break down knowledge into component parts.
      Synthesis—Students use creative thought to come to a conclusion.
      Evaluation—Highest level of questions. Students make judgments based on information they have learned. There is no one correct response for evaluation questions.
   Level Determination Question Set—Determines the best level (1, 2, 3, etc.) to present material based on the student's understanding of the subject matter to be presented.
   Presentation Type Determination Question Set—Determines the baseline level of knowledge of the user and assesses prerequisite knowledge required to proceed with the lesson. Determines Presentation Type used for each lesson (Brief, Standard or Detailed). This question set may include ten to twenty multiple choice, true/false and Column A—Column B match questions. The question set is fixed and does not necessarily have a right or wrong answer for each question.
   Intra-Lesson Question Set (based on Lesson Learning Objectives)—These are questions asked within a lesson. Ten (10) questions or more per learning objective with at least two questions each at the knowledge, comprehension, application, analysis, synthesis, and evaluation levels. Example Question types: True/False, Matching, Multiple Choice, Puzzle.
   Post-Level Presentation Question Set—This question set is used to evaluate a user's overall understanding and ability to utilize the presented material. The questions presented here are designed to not only ensure that the user has learned the information but more importantly is able to apply such knowledge so as to ensure an overall ability as defined by Bloom's Taxonomy including knowledge, comprehension, application, analysis, synthesis, and evaluation.
Question Set Explanations—For each question that is administered there is a brief explanation given to the student after a response is submitted for further reinforcement of learning. For evaluation questions, several explanations are offered since there is no one correct response.
Course Summary—Briefly defines each Level/Lesson and lists the learning objectives for each—thus enabling a student to drill down to that section of the eManual or the course presentation for reference.
Glossary—A complete listing of defined key words, terms and vocabulary from the course lessons.
eManual—A complete electronic interactive textbook presenting all the information defined within our subject course. It is a complete text book containing media rich content structured as Sections (Levels) and Chapters (Lessons) along with defined learning objectives.

In an embodiment, a method of dynamically generating electronic educational courses begins by determining an appropriate level for the user. Then, a pre-presentation evaluation is given. Upon completing the level determination assessment and the pre-presentation evaluations, the system will dynamically create a Presentation Process List containing, in order, all of the individual learning objectives to be presented for all lessons in a particular level. At the end of each learning objective, the system will randomly select 3-5 weighted questions from the Intra-Lesson Question Set to determine the student's understanding of the learning objective just presented. If the learning objective is satisfactorily completed, it is removed from the Presentation Process List. If the results are unsatisfactory (based on responses to the Intra-Lesson Questions), then the specific learning objective is increased in detail (e.g. moves from a brief presentation to a standard presentation), and remains on the list. As such, the learning objective will be repeated in the more detailed format before the lesson is considered complete. If a student receives unsatisfactory results after a second reiteration, then a full detailed explanation of the learning objective will be presented and the learning objective will be marked as complete and removed from the Presentation Process List.

Feedback, in the form of anonymous scores from evaluation questions, can be captured and passed along to a centralized location. The scores can be analyzed to make determinations about overall student achievement, question effectiveness, and content delivery and design.

All unsatisfactory learning objectives may be documented and the user will be provided with links to additional resources that can assist with mastering those specific objectives. The aforementioned process is repeated for each level in the application until the user has completed the entire course.

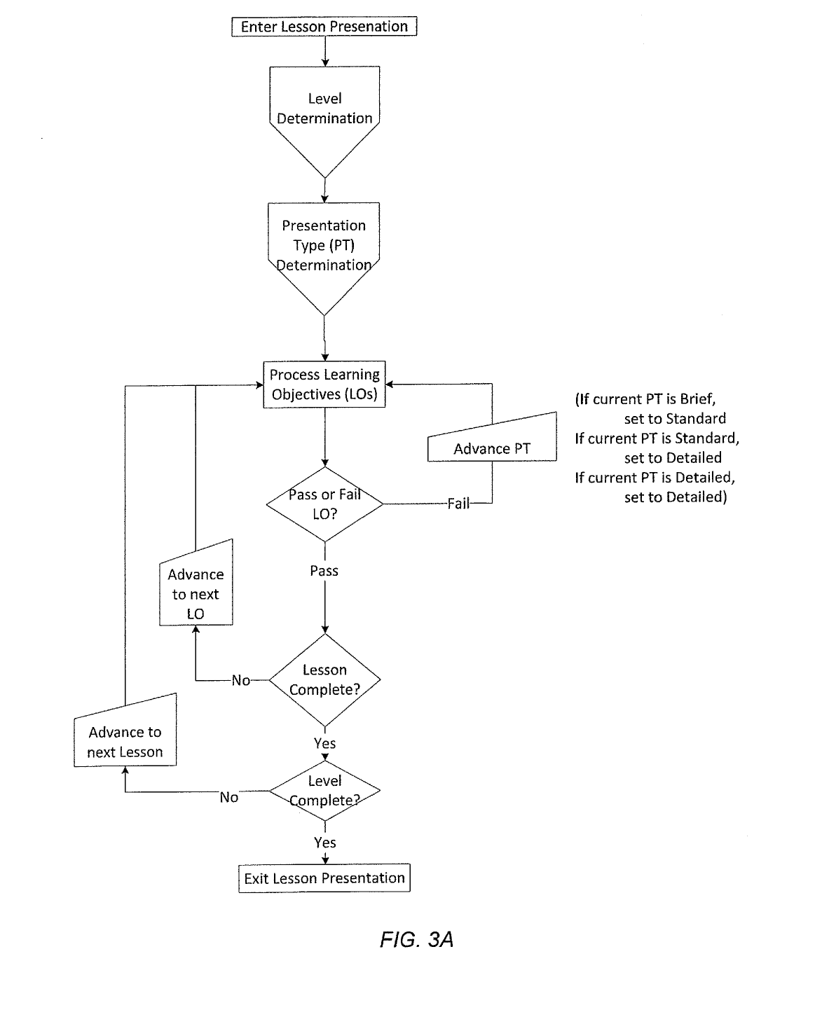

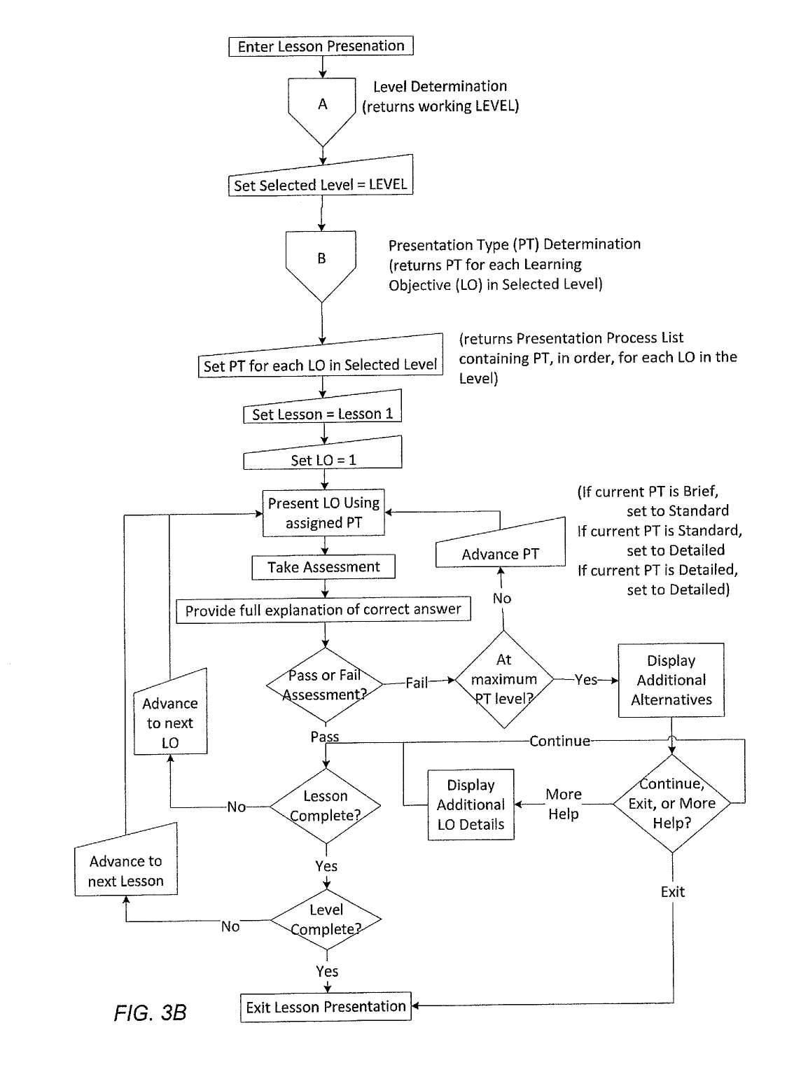

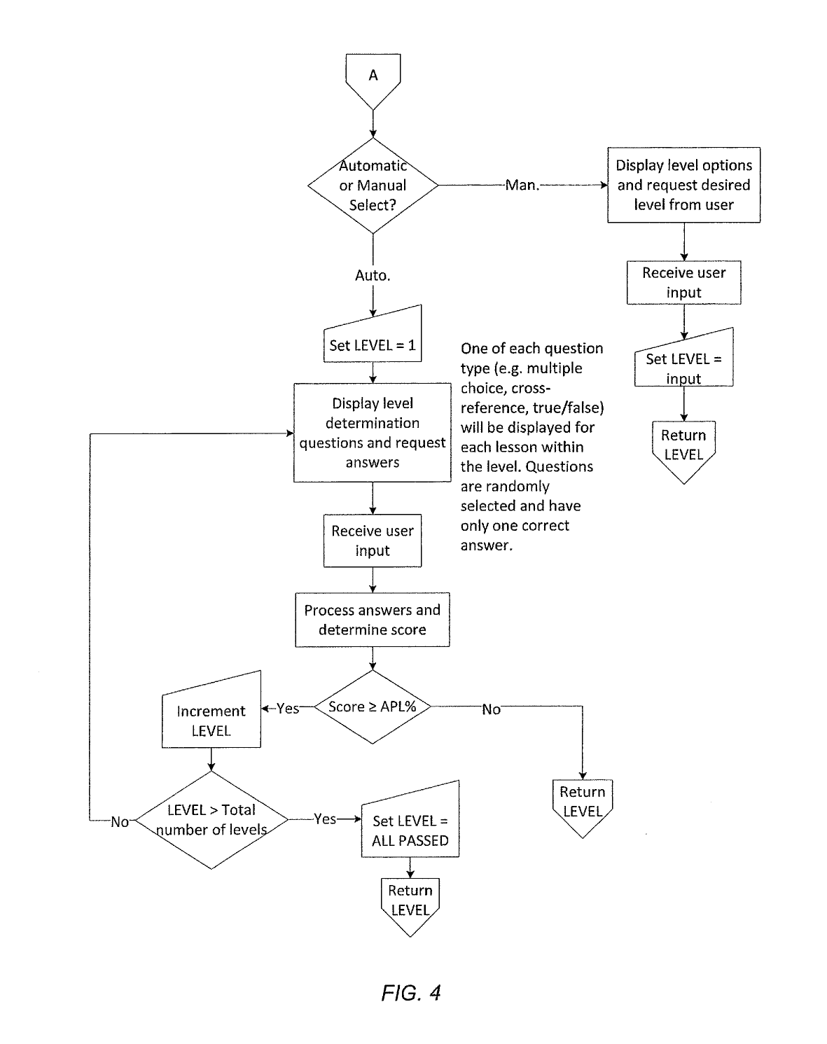

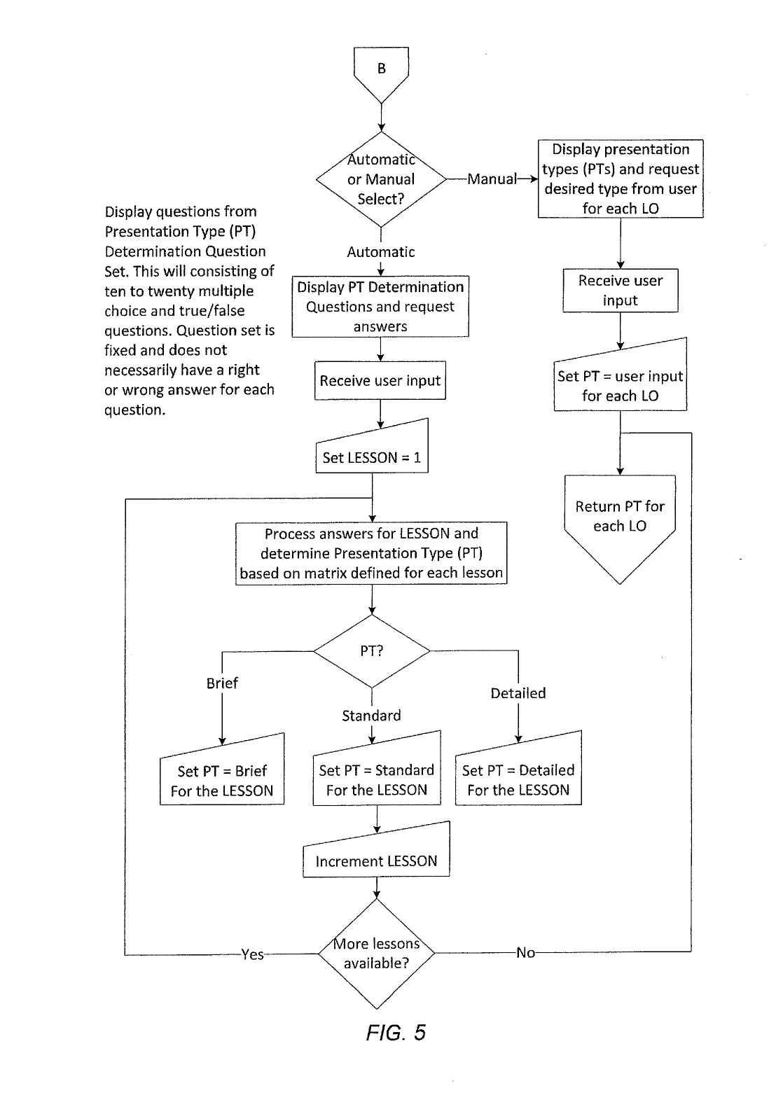

FIG. 3A is a flowchart of a high-level overview of a method of dynamically generating electronic educational courses according to an embodiment of the present invention. FIG. 3B is a more detailed flowchart of the method. As shown, after a user enters the course, his/her appropriate level with be determined. The level is automatically determined based on the user's understanding of the overall subject matter of the course. Level determination is detailed in FIG. 4 and will be explained below. Each level has a plurality of lessons associated with it. Each of the plurality of lessons has one or more Learning Objectives (LOs) associated with it. Therefore, once a level is determined there are a number of learning objectives associated with each lesson in the user's determined level. Once a proper level is determined, the user's Presentation Type (PT) (brief, standard, or detailed) for each Learning Objective is determined. The process evaluates the user's understanding of each lesson/learning objective, defines, and assigns a specific Presentation Type to be utilized during the presentation cycle. Presentation Type determinations are further detailed in FIG. 5 and are also explained below. Upon completion of the Presentation Type determinations, a Presentation Process List is dynamically created. The Presentation Process List contains, in order, all of the individual Learning Objectives and the corresponding determined Presentation Types for each of the Learning Objectives in the determined level.

The system then presents, in order, the learning objectives in the user's determined level. At the end of each learning objective, the user is given an assessment of the material from that lesson. This assessment may include three to five randomly selected weighted Learning Objective questions from the Learning Objective Question Set. The assessment determines the user's understanding of the Learning Objective just presented. If the user passes the assessment, then the Learning Objective and corresponding Presentation Type are marked as complete on the Presentation Process List and then the system checks to see if the user has completed all of his/her learning objectives. If so, then the level is complete and the user moves on to the next level.

If the user does not pass the assessment the first time, then the presentation type is upgraded and updated in the Presentation Process List. So, if the current presentation type is ‘brief’, the user would be upgraded to ‘standard’ and if the current presentation type is ‘standard’, the user would be upgraded to ‘detailed’. If the current presentation is already set to ‘detailed’, then the ‘detailed’ lesson would be repeated. If the user does not pass the assessment after taking the lesson in the upgraded presentation type, then the user is provided with a full explanation of the learning objective and then moves on to the next learning objective and lesson. Each time the specific actions are recorded on the Presentation Process List. This process is repeated until the user has successfully completed all lessons/learning objectives within the determined level of the course. The user can then advance to the next level if desired.

The level determination method is shown in further detail in FIG. 4. This method may be called when the user first enters a course to determine proper placement in a level of the course. As shown in the flowchart, the user also has the option to manually select his/her level and skip the assessment. Should the user choose to move forward with automatic assessment, the level determination questions for the first level are presented. Once the user responds, the answers are processed and a score is determined. If the user does not achieve a passing score (e.g. 95% or better), then the first level is returned as the user's beginning level. If the user does achieve a passing score, then the process repeats for the next level. This process continues until the user is placed in a level by producing a non-passing score or all of the levels are passed.

A method of determining the Presentation Type is shown in further detail in FIG. 5. This method may be called after the user has been placed in his/her appropriate level, but before the user begins any lessons in that level. The method is used to determine which version (detailed, standard, or brief) of an individual lesson should be presented to the user. As shown in the flowchart, the user also has the option to manually select his/her display presentation types and learning objectives. Should the user choose to move forward with automatic assessment, questions from the Presentation Type Determination Question Set are presented. Once the user responds, the answers are processed and used to determine the Presentation Type based on a matrix defined for each lesson or the weighting system provided below. Once the Presentation Type is determined, it is stored for that lesson and then the process is repeated for every lesson in that particular level. When all lessons are complete, the method returns a presentation type and a learning objective for each lesson in the level in the form of the Presentation Process List.

To determine Presentation Type using the Matrix concept, questions are defined as applicable to specific lessons. A single question can be associated to more than one lesson. Each lesson group (detailed, standard or brief) will be evaluated based on 1 to n number of question answers. All sub-answers of a question for e.g., answers “a”, “b”, “c”, “d” and “e” (if it is used) must be defined within the lesson group. They must appear at least once and can be repeated within the group. All questions at minimum will contain at least four answer choices.

Presentation Type may be determined in multiple ways—a simple and an advanced approach are described herein. In a simple approach, Lesson 01 will have three of the evaluation questions assigned to it: Q1, Q2 and Q3. That makes a total of 15 different sub answers (five for each question or Q1A, Q1B, Q1C, Q1D, Q1E, Q2a, Q2B, etc.). However, each question will only have one of the five possible answers assigned to it. The solution (supplied in the lesson plan) would contain something like:
a) L01-Detailed=“(Q1A, Q1B)+(Q2C, Q2D)+Q3A”—This is the formula to select the detailed presentation for the lesson. To select detailed the answer to question 1 must be either A or B, and in addition the answer to question 2 must be either C or D, and also the answer to question 3 has to be A.
b) L01-Standard=“(Q1C)+(Q2A, Q2B)+(Q3B, Q3C)”—This is the formula to select the standard presentation for the lesson. To select standard the answer to question 1 must be C, and in addition the answer to question 2 must be either A or B, and also the answer to question 3 must be either B or C.
c) L01—Brief=“(Q1D, Q1E)+(Q2C, Q2D, Q2E)+(Q3D)”—This is the formula to select the brief presentation for the lesson. To select standard the answer to question 1 must be either D or E, and in addition the answer to question 2 must be C, D, or E, and also the answer to question 3 must be D.

Note that each of the possible answers (Q1A, Q1B, Q1C, Q1D, Q1E, Q2A, Q2B, etc.) appears at least once in the three equations. They can be repeated if necessary. Each question does not have to appear as part of a sub-group selection (they do above, but it is not a requirement).

The brackets define an “or” function for specific answers and the “+” sign defines a “plus” operation. In other words, a logical “or” and a numeric addition are used to evaluate the result.

A matrix containing a row for each lesson group and a column for each question is created. If the question does not apply to the lesson group, it is automatically populated with a one for that lesson group (see below for a sample using this logic). If there is a two-way or three-way tie for the high count in the summary column then automatically the standard presentation is selected.

For example if the answers are Q1C, Q2B and Q3E, with the formulas defined above, (namely, L01-Detailed=“(Q1A, Q1B)+(Q2C, Q2D)+Q3A”; L01-Standard=“(Q1C)+(Q2A, Q2B)+(Q3B, Q3C)”; and L01—Brief=“(Q1 D, Q1 E)+(Q2C, Q2D, Q2E)+(Q3D)”) the resulting matrix would appear as follows:

| Lesson | 1^{st} or | 2^{nd} or | 3^{rd} or | Total | Comments/ |
|---|---|---|---|---|---|
| Group | Question | Question | Question | Across | Conclusions |
| Detailed | 0 | 0 | 0 | 0 | |
| Standard | 1 | 1 | 0 | 2 | Selected |
| | | | | | Presentation |
| | | | | | Method |
| Brief | 0 | 0 | 0 | 0 | |

In another example, the answers are Q1D, Q2D and Q3E, with the formulas defined as follows, L01-Detailed=“(Q1A, Q1B)+(Q2C, Q2D)”; L01-Standard=“(Q1C)+(Q2A, Q2B)+(Q3A, Q3B, Q3C)”; and L01—Brief=“(Q1 D, Q1 E)+(Q2C, Q2D, Q2E)+(Q3D)”. Note that Q3 does not have an answer assigned to presentation group “Detailed”. The resulting matrix would appear as follows:

| Lesson | 1^{st} or | 2^{nd} or | 3^{rd} or | Total | Comments/ |
|---|---|---|---|---|---|
| Group | Question | Question | Question | Across | Conclusions |
| Detailed | 0 | 1 | 1 | 2 | |
| Standard | 0 | 0 | 0 | 0 | Selected |
| | | | | | Presentation |
| | | | | | Method* |
| Brief | 1 | 1 | 0 | 2 | |

*Note that since there are two 2's in the “Total Across” column one in the “Detailed’ row and one in “Brief” row we would select the “Standard” method.

In an additional example, the answers are Q1A, Q213 and Q3E again, with the previously defined formulas, (namely L01-Detailed=“(Q1A, Q1B)+(Q2C, Q2D)+Q3A”; L01-Standard “(Q1C)+(Q2A, Q2B)+(Q3B, Q3C)”; and L01—Brief=“(Q1D, Q1E)+(Q2C, Q2D, Q2E)+(Q3D)”) the resulting matrix would appear as follows:

| Lesson | 1^{st} or | 2^{nd} or | 3^{rd} or | Total | Comments/ |
|---|---|---|---|---|---|
| Group | Question | Question | Question | Across | Conclusions |
| Detailed | 1 | 0 | 0 | 1 | |
| Standard | 0 | 1 | 0 | 1 | Selected |
| | | | | | Presentation |
| | | | | | Method* |
| Brief | 0 | 0 | 1 | 1 | |

*Again, the “Standard” would be selected as there are multiple rows with the same high number.

In an alternative, more advanced, approach, the answers/solution to each question the user is asked in an evaluation is weighted giving the method the flexibility it needs to accurately assess what the user needs. This allows for match questions, calculated answers, puzzles, true/false questions, and multiple choice questions.

For multiple choice questions—the most common and simple to understand—each answer is given a weight between 0.0 and 1.0, with 0.0 leading definitively to the ‘detailed’ version of the lesson and 1.0 leading definitively to the ‘brief’ version.

Questions are defined as applicable to specific lessons (for multi-level apps) or lesson objectives (for single level apps). Each question can be applied to multiple lessons/objectives and each lesson/objective can have multiple questions that apply to it.

Each lesson/objective will have a list of questions associated with it, and each of those questions will be given a weight which represents that question's importance toward the lesson/objective. The number on the weight is only important in relation to the weights of the other questions for a lesson/objective. For example, if Question 1 is twice as important for Lesson 1 than Question 2, the following weights would all be equivalent: Q1: 2, Q2: 1; Q1:10, Q2: 5; Q1:1, Q2:0.5. The importance is the ratio between the weights, which is always 2:1. For multi-level apps, this can be entirely compatible to what the original, “basic” approach produced.

In addition, each answer of a question will have a weight associated with it, which will represent the correctness of each available solution to the question. For questions that do not have a correct answer, it represents the depth into which corresponding lessons/objectives will go, with the depth of the material decreasing as the weight increases. This weight will always be a number between 0 and 1, inclusive. At the extremes, 0 indicates that the user needs the corresponding lessons/objectives to be as detailed as possible, and 1 indicates the user needs them to be as brief as possible.

To determine which module is chosen for a given lesson/objective, the following formula is used:

$$M = \frac{{W}_{q 0} * {W}_{a 0} + {W}_{q 1} * {W}_{a 1} + … + {w}_{qn} * {w}_{an}}{{W}_{q 0} * {W}_{q 1} + … + {W}_{qn}}$$

Or in its simplified form:

$$M = \frac{\sum {W}_{q} * {W}_{a}}{\sum {W}_{q}}$$

Where:
M=module
W_{q}=Question weight for Specific Question
Wₐ=Answer weight for user's answer to the specific question

Once M is calculated, it is then converted to Brief/Standard/Detailed as follows:
M<0.25=Detailed
(M>=0.25 and M<=0.75)=Standard
M>0.75=Brief

A simple example using parts of the basic algorithm from Memory Improvement:
1. A good memory can make you appear:
   a. Organized
   b. Caring
   c. Confident
   d. All of the above
2. A poor memory can be improved:
   a. Always
   b. Sometimes
   c. With effort
   d. Never

In the basic approach, these were both associated with Lesson 1—“A Good Memory Can Improve Your Life”, with the following method:
Detailed=Q1A, Q2D
Standard=Q1B, Q1C, Q2B, Q2C
Brief=Q1D, Q2A

Or, in another format:

| Answer | Detailed | Standard | Brief |
|---|---|---|---|
| Q1A | X | | |
| Q1B | | X | |
| Q1C | | X | |
| Q1D | | | X |
| Q2A | | | X |
| Q2B | | X | |
| Q2C | | X | |
| Q2D | X | | |

The advanced approach can simulate this by giving detailed answers a weight of 0.0, standard answers a weight of 0.5, and brief answers a weight of 1.0. This can be represented as follows:

| Answer | Weight |
|---|---|
| Q1A | 0.0 |
| Q1B | 0.5 |
| Q1C | 0.5 |
| Q1D | 1.0 |
| Q2A | 1.0 |
| Q2B | 0.5 |
| Q2C | 0.5 |
| Q2D | 0.0 |

However, because the advanced approach has more flexibility, answers can be given much more fine-tuned weights if desired. In this example, maybe Q2B is more accurate an answer than Q2C, so its weight could be increased to 0.7 and Q2C's weight could be decreased to 0.3, allowing for a more accurate assessment of the user's capabilities.

In the basic approach, all questions were treated equally. The advanced approach can do the same by simply making all question weights for a given lesson/objective the same. In the Memory Improvement example, this can be represented as a list of weights and questions as follows:

L1=(Q1: 1,Q2: 1)

However, again, the advanced approach allows for much more flexibility. If the first question was deemed 50% more important than the second question, the first question's weight just needs to be increased by 50% as well:

L1=(Q1: 1.5,Q2: 1) or to keep it as whole numbers: L1=(Q1: 3,Q2: 2)

Now, the approach will evaluate to the following numbers based on a user's answers (using the modified question and answer weights mentioned):

| A1 | A2 | W_{q1} | Wₐ₁ | W_{q2} | Wₐ₂ | M | Module chosen |
|---|---|---|---|---|---|---|---|
| A | A | 3 | 0.0 | 2 | 1.0 | (3 * 0.0 + 2 * 1.0)/(3 + 2) = 0.40 | Standard |
| A | B | 3 | 0.0 | 2 | 0.7 | (3 * 0.0 + 2 * 0.7)/(3 + 2) = 0.28 | Standard |
| A | C | 3 | 0.0 | 2 | 0.3 | (3 * 0.0 + 2 * 0.3)/(3 + 2) = 0.12 | Detailed |
| A | D | 3 | 0.0 | 2 | 0.0 | (3 * 0.0 + 2 * 0.0)/(3 + 2) = 0.00 | Detailed |
| B | A | 3 | 0.5 | 2 | 1.0 | (3 * 0.5 + 2 * 1.0)/(3 + 2) = 0.70 | Standard |
| B | B | 3 | 0.5 | 2 | 0.7 | (3 * 0.5 + 2 * 0.7)/(3 + 2) = 0.58 | Standard |
| B | C | 3 | 0.5 | 2 | 0.3 | (3 * 0.5 + 2 * 0.3)/(3 + 2) = 0.42 | Standard |
| B | D | 3 | 0.5 | 2 | 0.0 | (3 * 0.5 + 2 * 0.0)/(3 + 2) = 0.30 | Standard |
| C | A | 3 | 0.5 | 2 | 1.0 | (3 * 0.5 + 2 * 1.0)/(3 + 2) = 0.70 | Standard |
| C | B | 3 | 0.5 | 2 | 0.7 | (3 * 0.5 + 2 * 0.7)/(3 + 2) = 0.58 | Standard |
| C | C | 3 | 0.5 | 2 | 0.3 | (3 * 0.5 + 2 * 0.3)/(3 + 2) = 0.42 | Standard |
| C | D | 3 | 0.5 | 2 | 0.0 | (3 * 0.5 + 2 * 0.0)/(3 + 2) = 0.30 | Standard |
| D | A | 3 | 1.0 | 2 | 1.0 | (3 * 1.0 + 2 * 1.0)/(3 + 2) = 1.00 | Brief |
| D | B | 3 | 1.0 | 2 | 0.7 | (3 * 1.0 + 2 * 0.7)/(3 + 2) = 0.88 | Brief |
| D | C | 3 | 1.0 | 2 | 0.3 | (3 * 1.0 + 2 * 0.3)/(3 + 2) = 0.72 | Standard |
| D | D | 3 | 1.0 | 2 | 0.0 | (3 * 1.0 + 2 * 0.0)/(3 + 2) = 0.6 | Standard |

Exemplary Electronic Device

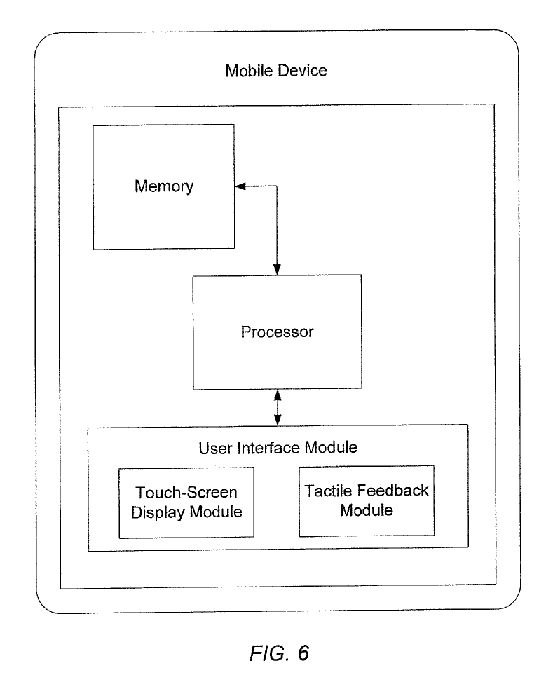

FIG. 6 is a block diagram showing an apparatus, an electronic device, according to an exemplary embodiment. It should be understood, however, that an electronic device as illustrated and hereinafter described is merely illustrative of an electronic device that could benefit from embodiments of the invention and, therefore, should not be taken to limit the scope of the invention. While one embodiment of the electronic device is illustrated for purposes of example, other types of electronic devices, such as, but not limited to, mobile phones, portable digital assistants (PDAs), tablets, mobile computing devices, desktop computers, televisions, gaming devices, laptop computers, media players, and other types of electronic systems, may readily employ embodiments of the invention. Moreover, the apparatus of an example embodiment need not be the entire electronic device, but may be a component or group of components of the electronic device in other example embodiments.

Furthermore, devices may readily employ embodiments of the invention regardless of their intent to provide mobility. In this regard, even though embodiments of the invention are described in conjunction with a mobile device, it should be understood that embodiments of the invention may be utilized in conjunction with a variety of other electronic devices.

The electronic device may comprise a processor or other processing circuitry. As used in this application, the term ‘circuitry’ refers to at least all of the following: hardware-only implementations (such as implementations in only analog and/or digital circuitry) and to combinations of circuits and software and/or firmware such as to a combination of processors or portions of processors/software including digital signal processor(s), software, and memory(ies) that work together to cause an apparatus, such as a mobile phone or tablet, to perform various functions and to circuits, such as a microprocessor(s) or portion of a microprocessor(s), that require software or firmware for operation, even if the software or firmware is not physically present. This definition of ‘circuitry’ applies to all uses of this term in this application, including in any claims.

As a further example, as used in this application, the term “circuitry” would also cover an implementation of merely a processor, multiple processors, or portion of a processor and its (or their) accompanying software and/or firmware.

Further, the processor(s) may comprise functionality to operate one or more software programs, which may be stored in memory and which may, among other things, cause the processor to implement at least one embodiment including, for example, one or more of the functions described above. The electronic device may comprise a user interface for providing output and/or receiving input. The electronic device may comprise an output device such as a ringer, a conventional earphone and/or speaker, a microphone, a display, and/or a user input interface, which are coupled to the processor. The user input interface, which allows the electronic device to receive data, may comprise means, such as one or more devices that may allow the electronic device to receive data, such as a keypad, a touch display, for example if the display comprises touch capability, and/or the like.

In an embodiment comprising a touch display, the touch display may be configured to receive input from a single point of contact, multiple points of contact, and/or the like. In such an embodiment, the touch display and/or the processor may determine input based on position, motion, speed, contact area, and/or the like.

The electronic device may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input.

The electronic device may comprise a memory device including, in one embodiment, volatile memory, such as volatile Random Access Memory (RAM) including a cache area for the temporary storage of data. The electronic device may also comprise other memory, for example, non-volatile memory, which may be embedded and/or may be removable. The non-volatile memory may comprise an EEPROM, flash memory or the like. The memories may store any of a number of pieces of information, and data. The information and data may be used by the electronic device to implement one or more functions of the electronic device.

Although FIG. 6 illustrates an example of an electronic device that may utilize embodiments of the invention including those described and depicted, for example, in FIG. 2, the electronic device of FIG. 6 is merely an example of a device that may utilize embodiments of the invention.

Embodiments of the invention may be implemented in software, hardware, application logic or a combination of software, hardware, and application logic. The software application logic and/or hardware may reside on the apparatus, a separate device, or a plurality of separate devices. If desired, part of the software application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media. In the context of this document, a “computer-readable medium” may be any tangible media or means that can contain, or store the instructions for use by or in connection with an instruction execution system, apparatus, or device, such as a computer, with one example of a computer described and depicted in FIG. 6. A computer readable medium may comprise a computer-readable storage medium that may be any tangible media or means that can contain or store the instructions for use by or in connection with an instruction execution system, apparatus, or device, such as a computer.

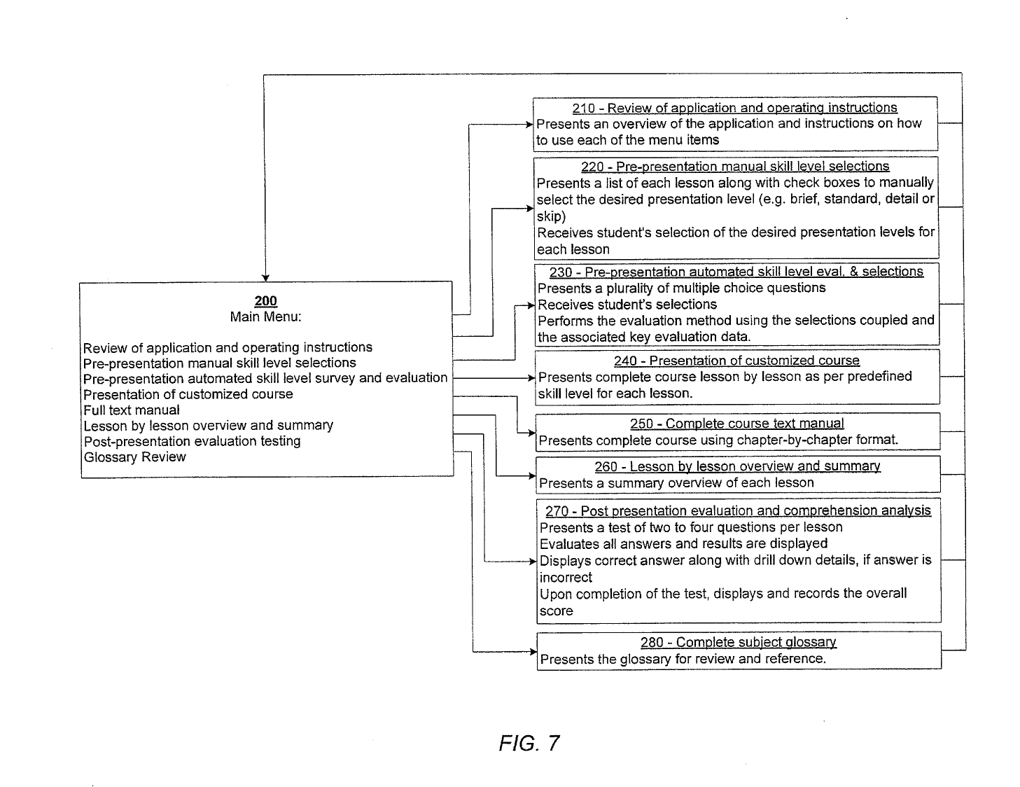

If desired, the different functions discussed herein may be performed in a different order and/or concurrently with each other. For example, option 270 of FIG. 7 may be performed after option 240. In another example, option 230 of FIG. 7 may be performed before option 220. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

### Exemplary Mobile Application

In an embodiment, the method of dynamically determining the customized content of electronically presented educational courses is implemented in a mobile application. The mobile application includes a menu-driven design, which is illustrated in FIG. 7. The method can also be implemented a number of ways including a website and a stand-alone software application. As shown in FIG. 7, the software application includes main menu 200 having the following selection options, which are described more fully below:
Review of application and operating instructions (option 210)
Pre-presentation manual skill level selections (option 220)
Pre-presentation automated skill level survey and evaluation (option 230)
Presentation of customized course (per default/manual/automated skill level selections) option (240)
Full text manual—presented in eBook format (option 250)
Lesson by lesson overview and summary (option 260)
Post-presentation evaluation testing (option 270)
Glossary Review (option 280)

Option 210 presents an overview of the application and instructions on how to use each of the menu items.

The software application includes a multi-level presentation divided into lessons covering the defined application subject. For each lesson, there will be a number of distinct presentation/outlines. For example, three distinct presentation levels, such as brief, standard, and detailed.

Option 220 presents a list of each lesson along with check boxes to manually select the desired presentation level (e.g. brief, standard, detail). The presentation level defines the specific skill level that will be applied to each lesson. This option, option 220, may be done in conjunction with the automated selection, option 230.

Option 230 presents a plurality (e.g. 15-20) of multiple choice, true/false, and or matching (e.g. match item in column A to item in column 8) questions. This option, option 230, may be done in conjunction with the manual selection, option 220. This option should be performed prior to taking the subject course to determine the users understanding and current knowledge level of the subject presented. These questions do not have specific correct answers, as the purpose here is to define the user's expertise level and not to test the user on the specific subject matter. This evaluation query will be structured around the lessons to be presented, thus allowing the system to make a lesson-by-lesson evaluation of the user's desires and existing level of expertise. The evaluation process will be performed automatically according to the method of dynamically determining the customized content of electronically presented educational courses, as described previously, which will use the user's answers and associated key evaluation data. The associated key evaluation data may be represented as a logical or Boolean expression, thus defining each lesson and associated weighted responses for each associated relative question. Questions may be applicable to multiple lessons, and are evaluated as such. Once completed, the evaluation's result will define which presentation level (brief, standard or detailed) should be utilized on a lesson-by-lesson basis.

Option 240 presents the complete course lesson-by-lesson according to the predefined skill level (e.g. default, manual, automated) for each lesson. The course may contain a table of contents, links (internal, pop-ups, glossary and web), graphics, pictures, videos, puzzles, interactive objects, and audio, as applicable. The course allows bookmarking (with summary and user selection ability). Also included is a glossary drill down/real-time search and real-time glossary drill down/search.

Option 250 presents the complete course text manual in book format. The manual may include a table of contents, index, links (internal, pop-ups, web (hyper-links) and glossary), graphics, pictures, tables, diagrams, figures, puzzles, interactive objects, video and audio, as applicable. The manual may use a flip page format and page numbers, which is the eBook format used on systems such as IPAD™ and KINDLE™. The manual may also be presented using a chapter-by-chapter format and may include book marking and tracking capability of all locations for easy recall. The manual includes all of the detailed presentation level lesson-by-lesson text. Also included is an introduction that describes the subject, benefits, and audience, a summary of the material, a bibliography, and a listing of applied references (detailed quotes, pictures, etc. as used). The manual may also incorporate a real-time glossary drill down and search.

Option 260 presents a summary overview of each lesson (e.g. one paragraph or less), which allows the user to scroll through the overview as desired.

Option 270 presents a comprehensive post-presentation evaluation question set. The question set will have a plurality of questions (e.g. two to eight) per lesson. During the testing process, the application will randomly select a number of questions (e.g. two to three) from a lesson sub-set of questions and present the questions in random order. This process allows the user to take the test countless number of times while each time the questions are different and in a different random order. The user can then select answers for each question. The correct answer will be displayed along with drill down details regardless of the answer provided. Upon completion of the test, the overall score is given to the user and recorded.

Option 280 presents the glossary for review and references and may also include a glossary search.

Each of options 210-280 also includes a selection that will return the user to the main menu.

It will be seen that the advantages set forth above, and those made apparent from the foregoing description, are efficiently attained and because certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

What is claimed is:

1. A system for dynamically generating electronic educational courses delivered to a user comprising:
a processor; and
a user interface in communication with said processor, said user interface including a display and a user input mechanism,
wherein said processor is configured to:
(a) determine an appropriate level for the user;
(b) perform a pre-presentation evaluation of the user;
(c) dynamically create a presentation process list containing individual learning objectives to be presented for all lessons in a particular level, wherein the presentation process list is dynamically created based upon the pre-presentation evaluation of the user;
(d) select and display a presentation of one of the learning objectives from the presentation process list;
(e) randomly select and display weighted questions from an intra-lesson question set to receive the user's answers and determine the user's understanding of the learning objective presented in step (d);
(f) if the user answered the displayed questions satisfactory, remove the learning objective presented in step (d) from the presentation process list;
(g) if the user does not answer the displayed questions satisfactory, increase a level of detail of the presentation and repeat steps (d) through (f) for that learning objective;
(h) if the user does not answer the displayed questions satisfactory after the detail of the presentation has been increased per step (g), present a full detailed explanation of the learning objective to the user and remove the learning objective presented in step (d) from the presentation process list;
(i) repeat steps (d) through (h) for each remaining learning objective for current lesson;
(j) once all learning objectives for the current lesson have been removed from the presentation process list, select a new lesson and repeat steps (d) through (i).

2. A non-transitory computer readable medium having stored thereon software instructions that, when executed by a processor, cause the processor to dynamically generate electronic educational courses delivered to a user, by executing the steps comprising:
(a) determine an appropriate level for the user;
(b) perform a pre-presentation evaluation of the user;
(c) dynamically create a presentation process list containing individual learning objectives to be presented for all lessons in a particular level, wherein the presentation process list is dynamically created based upon the pre-presentation evaluation of the user;
(d) select and display a presentation of one of the learning objectives from the presentation process list;
(e) randomly select and display weighted questions from an intra-lesson question set to receive the user's answers and determine the user's understanding of the learning objective presented in step (d);
(f) if the user answered the displayed questions satisfactory, remove the learning objective presented in step (d) from the presentation process list;
(g) if the user does not answer the displayed questions satisfactory, increase a level of detail of the presentation and repeat steps (d) through (f) for that learning objective;
(h) if the user does not answer the displayed questions satisfactory after the detail of the presentation has been increased per step (g), present a full detailed explanation of the learning objective to the user and remove the learning objective presented in step (d) from the presentation process list;
(i) repeat steps (d) through (h) for each remaining learning objective for current lesson;
(j) once all learning objectives for the current lesson have been removed from the presentation process list, select a new lesson and repeat steps (d) through (i).

3. A method for dynamically generating electronic educational courses comprising:
providing a user interface including display and user input;
providing a processor in communication with the user interface, wherein the processor is configured to:
(a) determine an appropriate level for the user;
(b) perform a pre-presentation evaluation of the user;
(c) dynamically create a presentation process list containing individual learning objectives to be presented for all lessons in a particular level, wherein the presentation process list is dynamically created based upon the pre-presentation evaluation of the user;
(d) select and display a presentation of one of the learning objectives from the presentation process list;
(e) randomly select and display weighted questions from an intra-lesson question set to receive the user's answers and determine the user's understanding of the learning objective presented in step (d);
(f) if the user answered the displayed questions satisfactory, remove the learning objective presented in step (d) from the presentation process list;
(g) if the user does not answer the displayed questions satisfactory, increase a level of detail of the presentation and repeat steps (d) through (f) for that learning objective;
(h) if the user does not answer the displayed questions satisfactory after the detail of the presentation has been increased per step (g), present a full detailed explanation of the learning objective to the user and remove the learning objective presented in step (d) from the presentation process list;
(i) repeat steps (d) through (h) for each remaining learning objective for current lesson;
(j) once all learning objectives for the current lesson have been removed from the presentation process list, select a new lesson and repeat steps (d) through (i).
